(19) United States
(12) Patent Application Publication
(10) Pub. No.: US 2008/0027967 A1
(43) Pub. Date: Jan. 31, 2008

(54) Method, Apparatus, and Computer Program Product for Providing Intelligent Handling of Web Activity Based on Measured Resource Utilization

(76) Inventors: Zachary Adam Garbow, Rochester, MN (US); Kevin Glynn Paterson, San Antonio, TX (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/460,304

(22) Filed: Jul. 27, 2006

(51) Int. Cl. G06F 7/00

(52) U.S. Cl. 707/102

(57) ABSTRACT

A method, apparatus, and computer program product for measuring resource utilization of web pages and providing intelligent handling of web activity based on the measured resource utilization. Resource utilization (e.g., CPU and/or memory utilization) on one or more client systems is measured in response to the client system loading and/or running a web page. A plurality of these resource utilization measures are aggregated for each of a plurality of web pages. Hence, each web page has an aggregate resource utilization measure associated therewith. These aggregate measures are used to provide intelligent handling of web activity, such as search result prioritization, link and/or content categorization and management, and power conservation. In this way, a web page may be automatically created based on the aggregate measures so that when interpreted on a client system the web page displays content tailored to the client system and/or computing context.

### BACKGROUND OF THE INVENTION

1. Field of Invention

The present invention relates in general to the digital data processing field. More particularly, the present invention relates to providing intelligent handling of web activity, such as search result prioritization, based on measured resource utilization.

2. Background Art

Since the dawn of the computer age, computer systems have evolved into extremely sophisticated devices that may be found in many different settings. Computer systems typically include a combination of hardware (e.g., semiconductors, circuit boards, etc.) and software (e.g., computer programs). As advances in semiconductor processing and computer architecture push the performance of the computer hardware higher, more sophisticated and complex computer software has evolved to take advantage of the higher performance of the hardware, resulting in computer systems today that are much more powerful than just a few years ago.

Years ago, computers were isolated devices that did not communicate with each other. But, today computers are often connected in networks, such as the Internet or World Wide Web, and a user at one computer, often called a client, may wish to access information at multiple other computers, often called servers, via a network. Searching is the primary mechanism used to retrieve information from the Internet. Users typically search the web pages of the Internet using a search engine, such as Yahoo! and Google. These search engines index hundreds of millions of web pages and respond to close to or more than one hundred million queries every day.

To accomplish this formidable task, search engines typically employ three major elements. The first is an agent, often called a spider, robot, or crawler. The crawler visits a web page, reads it, and then follows links to other pages within the site. The crawler typically returns to the site on a regular basis, such as every month or two, to look for changes. The crawler stores the information it finds in the second part of the search engine, which is the index. Sometimes new pages or changes that the crawler finds may take some time to be added to the index. Thus, a web page may have been “crawled” but not yet “indexed.” Until the web page has been added to the index, the web page is not available to those searching with the search engine.

The third part of the search engine is the program that interrogates the millions of pages recorded in the pre-created index to find matches to a search and ranks them in order that the program believes is most relevant, which is often referred to as web site ranking. Web site ranking is extremely important to the user because a simple search using common terms may match thousands or even tens of thousands of pages, which would be virtually impossible for the user to individually sort through in an attempt to determine relevancy.

In order to aid the user, search engines typically determine relevancy by following a set of rules, which is commonly known as the web site ranking algorithm. Exactly how a particular search engine's algorithm works is usually a closely-guarded trade secret. But, all major search engines follow the same generally-accepted methods described below. One of the main methods in a web site ranking algorithm involves the location and frequency of keywords (search terms) on a web page, which is known as the location/frequency method. For example, web site-ranking algorithms often assume that terms appearing in a title control-tag are more relevant than terms appearing at other locations in the page. Further, many web site ranking algorithms will also check to determine whether the search keywords appear near the top of a web page, such as in the headline or in the first few paragraphs of text. They assume that a page relevant to the topic will mention those words at the beginning. Frequency of keywords is the other major factor that web site ranking algorithms use to determine relevancy. The web site ranking algorithm analyzes how often keywords appear in relation to other words in a web page and deems more relevant those with a higher frequency.

In addition to the location/frequency method, which is an on-the-page criteria, search engines also typically make use of off-the-page criteria. Off-the-page criteria are those that use data external to the page itself. Chief among these is link analysis. By analyzing how pages link to each other, the web site ranking algorithm attempts to determine both the subject of a page and the relative importance of the page with respect to other pages.

Hence, as previously described above, the web site ranking algorithm is a very sophisticated technique. The web site ranking algorithm is largely hidden from the user who is requesting the search, who often has little or no control over the criteria used in the web site ranking algorithm. It is important to note that when determining web page relevancy, neither the web site ranking algorithm nor the user's control, if any, over the criteria used in the web site ranking algorithm takes into account the varied capabilities of the devices that access the Internet.

A wide and growing disparity exists with respect to computing resources of Internet accessible devices. The assortment of devices that connect to and access content from the Internet ranges from powerful servers, to traditional PCs, to mobile devices and cellphones. At the same time, the type of content available on the Internet continues to diversify. In addition to traditional, static content and text, the Internet is experiencing a proliferation of interactive content, web programs (e.g., using Macromedia's Flash, Sun Microsystem's Java, etc.) and intensive graphics. While much of this content is programmed assuming that the majority of users will be accessing it using a device having adequate computing resources (e.g., a “standard” PC with an adequate processor and memory), this is increasingly a poor assumption. These developments pose difficulties in the handling of web activity. When the web site ranking algorithm of a search engine determines web page relevancy, for example, some of the web pages deemed by the web site ranking algorithm as being most relevant may, in fact, be inaccessible to a particular device that has inadequate computing resources to handle those web pages.

Thus, without an ability to provide intelligent handling of web activity based on capabilities of devices that access web pages, difficulties in handling web activity will continue.

### SUMMARY OF THE INVENTION

According to a preferred embodiment of the present invention, intelligent handling of web activity is provided based on a historical measure of resource utilization for web pages. Resource utilization (e.g., CPU and/or memory utilization) on one or more client systems is measured in response to the client system loading and/or running a web page. A plurality of these resource utilization measures are aggregated for each of a plurality of web pages. Hence, each web page has an aggregate resource utilization measure associated therewith. These aggregate measures are used to provide intelligent handling of web activity, such as search result prioritization, link and/or content categorization and management, and power conservation. In this way, a web page may be automatically created based on the aggregate measures so that when interpreted on a client system the web page displays content tailored to the client system and/or computing context. According to the preferred embodiments of the present invention, the creation and use of the historical measure of resource utilization may be implemented within the context of an indexing service, such as a search server, or a local indexing application, such as a client application (e.g., browser, browser plug-in, etc.).

The foregoing and other features and advantages of the present invention will be apparent from the following more particular description of the preferred embodiments of the present invention, as illustrated in the accompanying drawings.

### BRIEF DESCRIPTION OF THE DRAWINGS

The preferred exemplary embodiments of the present invention will hereinafter be described in conjunction with the appended drawings, where like designations denote like elements.

FIG. 1 is a block diagram of an example system for implementing an embodiment of the present invention.

FIG. 2 is a pictorial representation of a graphical user interface, according to an embodiment of the present invention.

FIG. 3 is a pictorial representation of a graphical user interface, according to another embodiment of the present invention.

FIG. 4 is a flow diagram of example processing for measuring resource utilization on a client system in response to the client system loading and/or running a web page, according to an embodiment of the present invention.

FIG. 5 is a flow diagram of example processing for search result prioritization using resource utilization measures, according to an embodiment of the present invention.

FIG. 6 is a flow diagram of example processing for link and/or content categorization and management using resource utilization measures, according to an embodiment of the present invention.

FIG. 7 is a flow diagram of example processing for power conservation using resource utilization measures, according to an embodiment of the present invention.

### DETAILED DESCRIPTION OF THE PREFERRED EMBODIMENTS

1.0 Overview

In accordance with a preferred embodiment of the present invention, intelligent handling of web activity is provided based on a historical measure of resource utilization for web pages. Resource utilization (e.g., CPU and/or memory utilization) on one or more client systems is measured in response to the client system loading and/or running a web page. A plurality of these resource utilization measures are aggregated for each of a plurality of web pages. Hence, each web page has an aggregate resource utilization measure associated therewith. These aggregate measures are used to provide intelligent handling of web activity, such as search result prioritization, link and/or content categorization and management, and power conservation. In this way, a web page may be automatically created based on the aggregate measures so that when interpreted on a client system the web page displays content tailored to the client system and/or computing context. According to the preferred embodiments of the present invention, the creation and use of the aggregate measures of resource utilization may be implemented within the context of an indexing service {such as a search server (e.g., Yahoo!, Google, etc.) or a peer-to-peer network (wherein one peer queries another peer)} or a local indexing application {such as a client application (e.g., a browser, a browser plug-in, etc.), a peer-to-peer network (wherein the historical measure is kept in a local index), or a distributed system (wherein the historical measure is bumped to a server)}.

2.0 Detailed Description

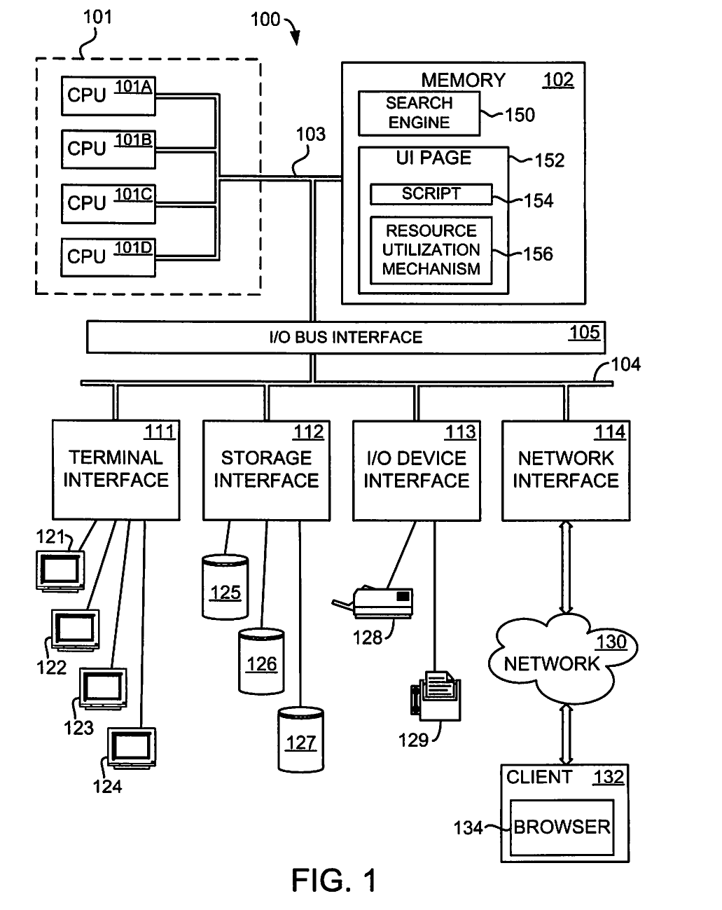

Referring to the Drawing, wherein like numbers denote like parts throughout the several views, FIG. 1 depicts a high-level block diagram representation of a computer system 100 connected to a client 132 via a network 130, according to an embodiment of the present invention. The major components of the computer system 100 include one or more processors 101, a main memory 102, a terminal interface 111, a storage interface 112, an I/O (Input/Output) device interface 113, and communications/network interface 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 includes a search engine 150 and a user interface page 152. Although the search engine 150 and the user interface page 152 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the search engine 150 and the user interface page 152 are illustrated as being contained within the main memory 102, these elements are not necessarily all completely contained in the same storage device at the same time.

In an embodiment, the search engine 150 includes instructions capable of executing on the processor 101 or statements capable of being interpreted by instructions executing on the processor 101 to perform the functions as further described below. In another embodiment, the search engine 150 may be implemented in microcode. In another embodiment, the search engine 150 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiments many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support InfiniBand. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client 132 includes a browser 134. The browser 134 downloads the user interface page 152, interprets the control tags and data in the user interface page 152, and executes or interprets the script 154 and the resource utilization mechanism 156. The browser 134, the script 154, and the resource utilization mechanism 156 may include instructions or statements capable of being executed on an unillustrated processor, analogous to the processor 101, or interpreted by instructions executing on the unillustrated processor, in order to perform the functions as further described below. In an embodiment, the script 154 and the resource utilization mechanism 156 are implemented via JavaScript, but in other embodiments, the script 154 and the resource utilization mechanism 156 may be implemented via an applet, an XML (Extensible Markup Language) document, or any other appropriate language or protocol. The user interface page 152 may be implemented via HTML (Hypertext Markup Language), XML, or any other appropriate markup language. The client 132 may also include any or all of the hardware and/or software elements previously described above for the computer system 100.

Although the browser 134, the search engine 150, the user interface page 152, the script 154, and the resource utilization mechanism 156 are illustrated as being separate elements, in other embodiments the functions of some or all of them may be combined. For example, in an embodiment, some or all of the browser 134, the user interface page 152, the script 154, and the resource utilization mechanism 156 are not present or not used, and their functions are performed by the search engine 150.

It should be understood that FIG. 1 is intended to depict the representative major components of the computer system 100, the network 130, and the client 132 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100 and/or the client 132, cause the computer system 100 and/or the client 132 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 and/or the client 132 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

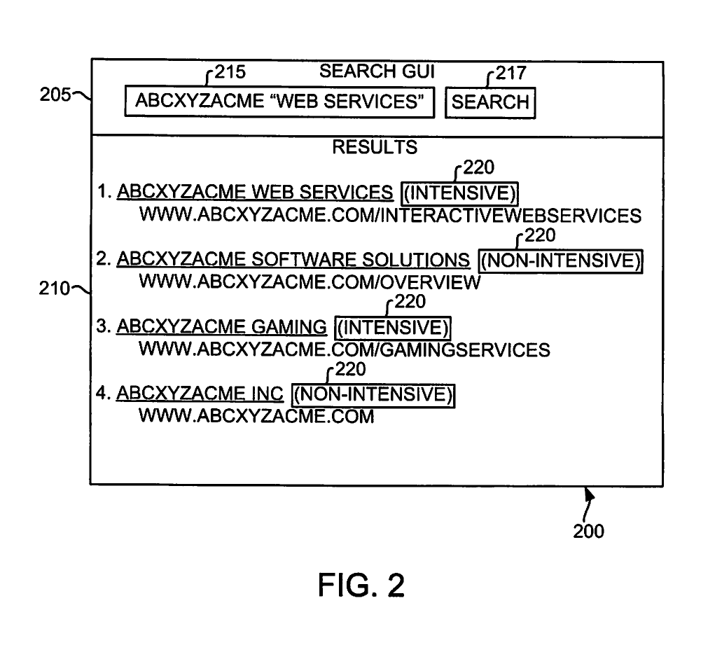

FIG. 2 depicts a pictorial representation of a graphical user interface 200, according to an embodiment of the present invention. The graphical user interface 200 is displayed by the browser 134 by interpreting the user interface page 152, interpreting or executing the script 154, and/or interpreting or executing the resource utilization mechanism 156. The graphical user interface 200 includes a search pane 205 and a search results pane 210. The search pane 205 includes an entry field for adding search terms 215 and a button 217 to perform a search.

After the user enters the search terms 215 in the entry field and selects the button 217 to perform a search, in response, script 154 submits the search terms 215 to the search engine 150. After the search engine 150 performs the search using search terms 215, the script 154 downloads the search results, and the script 154 displays the search results in the search result pane 210. In addition, in accordance with the preferred embodiments of the present invention, the resource utilization mechanism 156 downloads indicia 220 and displays the indicia 220 in the search result pane 210. These indicia 220, as discussed in detail below, are preferably based on an aggregated measure of resource utilization associated with each web page listed in the search results. As illustrated in FIG. 2, indicia 220 indicate through the use of text whether or not each web page listed in the search results is resource intensive. Those skilled in the art will appreciate, however, that indicia 220 may take other forms such as symbols, may be displayed for a subset of the web pages listed in the search results (e.g., indicia 220 may be displayed only for those web pages that are resource intensive or that require a level of resource availability greater than a threshold level), and/or may show greater detail with respect to the level of resource intensity (e.g., indicia 220 may take the form of a numerical rating or a graphical representation such as a bar chart).

Although the search pane 205 and the search results pane 210 are illustrated in FIG. 2 as being displayed concurrently, in another embodiment they may be displayed separately.

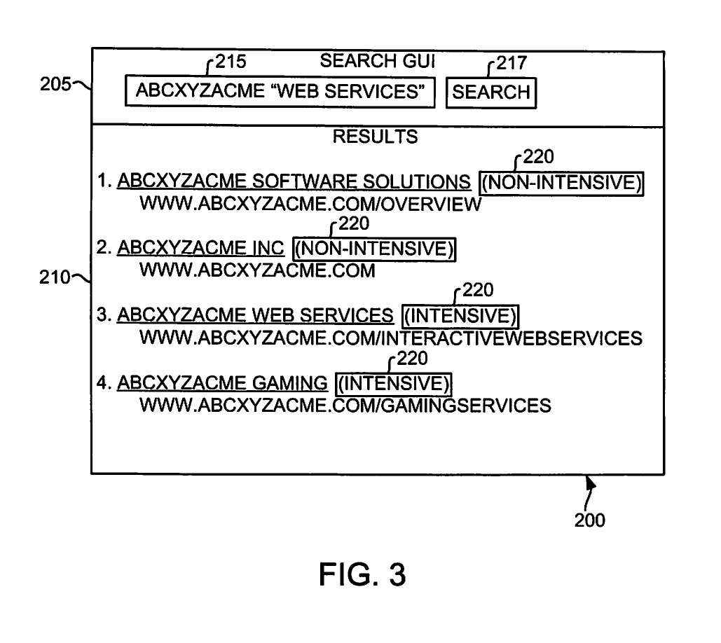

FIG. 3 depicts a pictorial representation of a graphical user interface 300, according to another embodiment of the present invention. The graphical user interface 300 shown in FIG. 3 is almost identical to the graphical user interface 200 shown in FIG. 2 except that resource utilization mechanism 156 reorders the search results based on each web page's aggregated measure of resource utilization. Hence, in the embodiment shown in FIG. 3 search result prioritization is based the aggregated measure of resource utilization associated with each web page in the search results. Links to web pages that are not resource intensive bubble up the list, while links to web pages that are resource intensive drop down the list. In an alternative embodiment, a link to a different version of a resource intensive web page (the different version of the original web page being less resource intensive than the original web page) may be substituted for the link to the original web page instead of dropping it down the list.

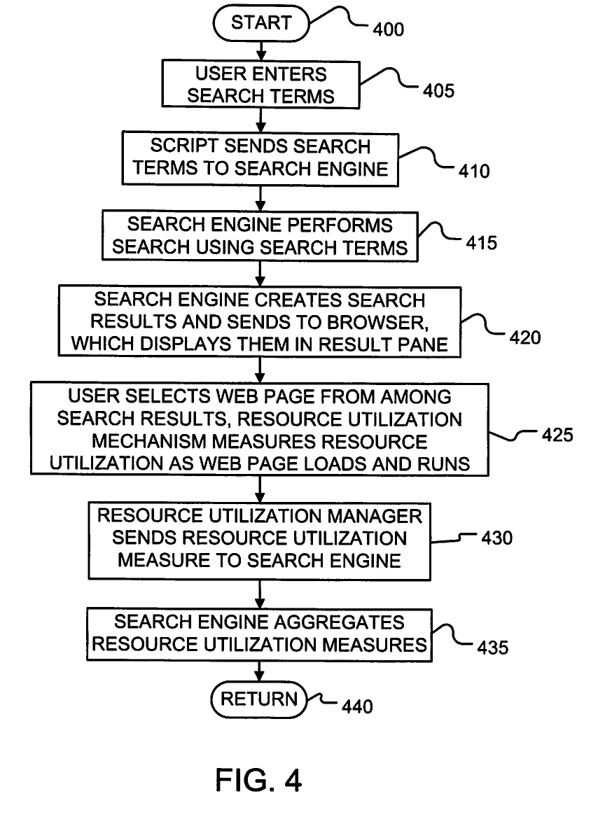

FIG. 4 is a flow diagram of example processing for measuring resource utilization on a client system in response to the client system loading and/or running a web page, according to an embodiment of the present invention. In carrying out the processing for measuring resource utilization on a client system in response to the client system loading and/or running a web page, the steps discussed below (blocks 400-440) are performed. These steps are set forth in their preferred order. It must be understood, however, that the various steps may occur at different times relative to one another than shown, or may occur simultaneously. Moreover, those skilled in the art will appreciate that one or more of the steps may be omitted. Control begins a block 400. Control then continues to block 405 where the user enters the search terms 215 in the entry field via user interface 200 and selects the “Search” button 217. Control then continues to block 410 where the script 154 sends the search terms 215 to the search engine 150. Control then continues to block 415 where the search engine 150 performs the search using the search terms 215. Control then continues to block 420 where the search engine creates the search results and sends them to the browser 134, which displays the search results in the results pane 210 by interpreting the downloaded page.

Control then continues to block 425 where the user selects a link to a web page from among the results listed in the results pane 210, and the resource utilization mechanism 156 measures resource utilization (e.g., CPU and/or memory utilization) on the client system 132 as the selected web page is loaded and/or run. For example, the resource utilization mechanism 156 may interact with traditional system resource measuring software, such as Microsoft's Windows Task Manager, to measure changes that occur in CPU usage and/or memory available as the selected web page is loaded and/or run on the client system 132. Alternatively, the resource utilization mechanism 156 may itself measure resource utilization. In general, the resource utilization measured includes CPU and memory utilization primarily, but extends to other measurements as well.

Control then continues to block 430 where the resource utilization mechanism 156 sends the resource utilization measure to the search engine 150. The search engine associates the resource utilization measure received from the client system 132 with the selected web page. In addition to being associated with a particular web page, the resource utilization measure may be associated with web sites and/or domains. Control then continues to block 435 where the search engine aggregates the resource utilization measure received from the client system 132 with other resource utilization measures received from other client systems in response to loading and/or running the same web page. For example, the resource utilization measures may be aggregated to determine an average. The resource utilization measures may be grouped into categories based one or more characteristics of the client system from which the resource utilization measures were received, and then the resource utilization measures for each group may be aggregated to determine an average for each group. For example, a different average may be calculated for mobile clients vs. desktop clients, and/or based on the type of browser used by the client system. In addition, the aggregated measure associated with a particular web page, web site, and/or domain, may be updated over time to reflect changes in the content.

Control then continues to block 440 where the logic of FIG. 4 returns. The logic of FIG. 4 may be executed at any time to allow the user to add search terms, or to change the search terms currently being displayed on the user interface 200.

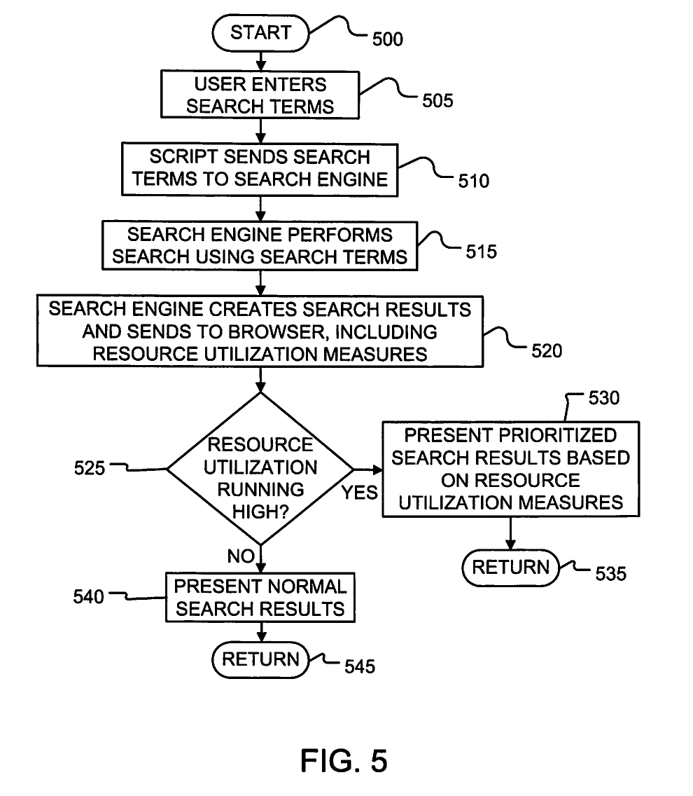

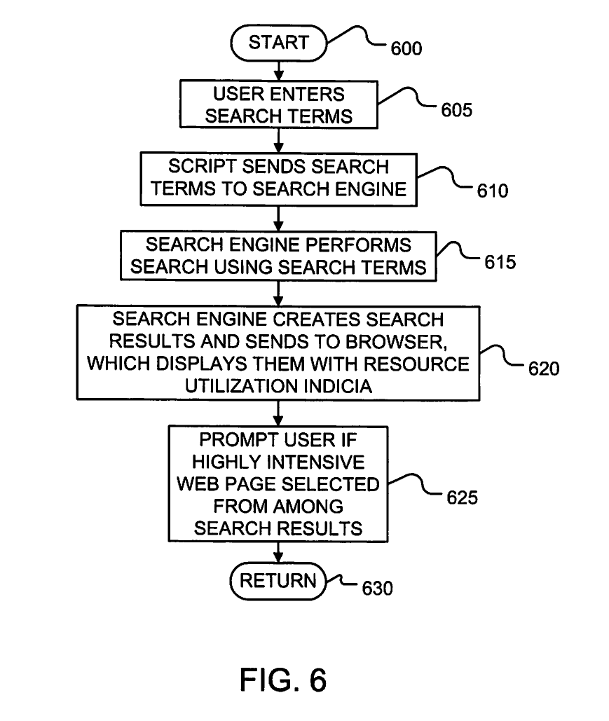

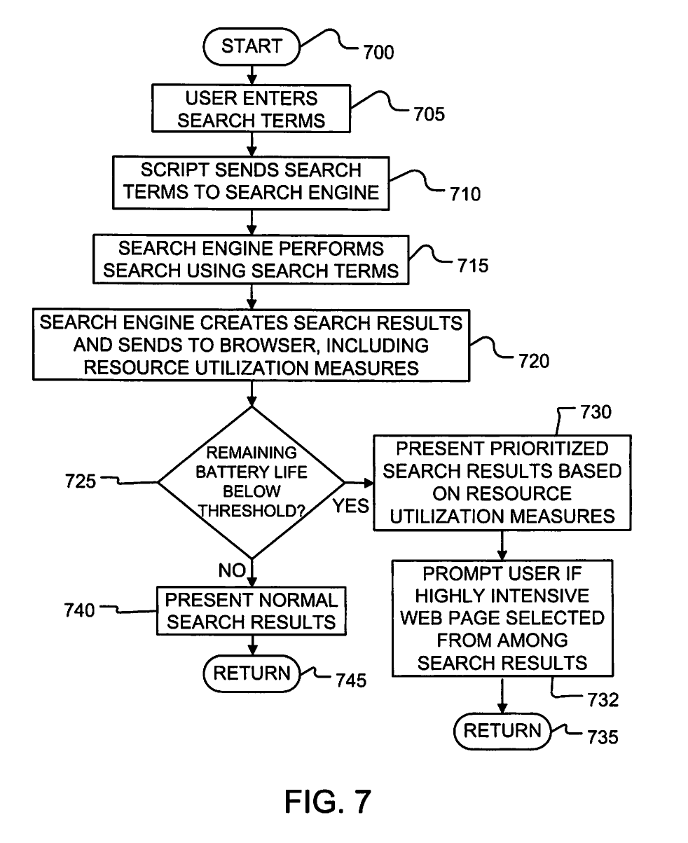

The resource utilization measures associated with web pages, web sites, and/or domains are used to provide intelligent handling of web activity, such as search result prioritization (discussed below with reference to FIG. 5), link and/or content categorization and management (discussed below with reference to FIG. 6), and power conservation (discussed below with reference to FIG. 7). In this way, a web page may be automatically created based on the resource utilization measures so that when interpreted on a client system the web page displays content tailored to the client system and/or computing context. According to the preferred embodiments of the present invention, the creation and use of the resource utilization measures may be implemented within the context of an indexing service [such as a search server (e.g., Yahoo!, Google, etc.) or a peer-to-peer network (one peer queries another peer)] or a local indexing application [such as a client application (e.g., a browser, a browser plug-in, etc.), a peer-to-peer network (keep the historical measure in a local index), or a distributed system (bump the historical measure to a server)]. By tracking and calculating resource utilization of web pages, web sites and domains, it is possible for client-side applications, for example, to take intelligent measures to provide improved management of Internet activity.

FIG. 5 is a flow diagram of example processing for search result prioritization using resource utilization measures, according to an embodiment of the present invention. In carrying out the processing for search result prioritization, the steps discussed below (blocks 500-545) are performed. These steps are set forth in their preferred order. It must be understood, however, that the various steps may occur at different times relative to one another than shown, or may occur simultaneously. Moreover, those skilled in the art will appreciate that one or more of the steps may be omitted. Control begins a block 500. Control then continues to block 505 where the user enters the search terms 215 in the entry field via user interface 200 and selects the “Search” button 217. Control then continues to block 510 where the script 154 sends the search terms 215 to the search engine 150. Control then continues to block 515 where the search engine 150 performs the search using the search terms 215.

Control then continues to block 520 where the search engine 150, along with the resource utilization mechanism 156, creates the search results and sends them to the browser 134, along with historical resource utilization measures associated with web pages, web sites, and/or domains within the search results. In this regard, a web page is created that when interpreted on the accessing device displays either normal search results or prioritized search results having content based on the historical resource utilization measures. The normal search results are provided by the web site ranking algorithm of the search engine 150. The resource utilization mechanism 156 modifies the normal search results based on the historical resource utilization measures, which were previously calculated as discussed above with reference to FIG. 4, to provide the prioritized search results. Control then continues to block 525 where the resource utilization of the accessing device is measured and compared to a threshold level. If the measured resource utilization of the accessing device is running high (block 525=Yes), control then continues to block 530 where the prioritized search results are displayed in the results pane 210 by interpreting the downloaded page based on the historical resource utilization measures. Control then continues to block 535 where the logic of FIG. 5 returns. In an alternate embodiment, the client can send the resource utilization to the search engine along with the search query, and the results can be modified appropriately by the search server's algorithm before returning the results to the client. In this example, the server handles the processing requirements of filtering the results, which may be beneficial in cases where the client's system is running high.

On the other hand, if the measured resource utilization of the accessing device is not running high (block 525=No), control then continues to block 540 where the normal search results are displayed in the results pane 210 by interpreting the downloaded page. Control then continues to block 545 where the logic of FIG. 5 returns.

The logic of FIG. 5 may be executed at any time to allow the user to add search terms, or to change the search terms currently being displayed on the user interface 200.

In the example shown in FIG. 5, search results are automatically prioritized if the resource utilization of the accessing device is running high. In general, search results may be automatically prioritized based on a user's environment and the accessing device. For instance, if the CPU utilization on the accessing device is currently running high at the time of the web query, the resource utilization mechanism 156 may present the search results such that pages with lower CPU utilization bubble to the top. This avoids adding load to already taxed processor resources and keeps the web content from negatively affecting other processes on the accessing device. Those skilled in the art will recognize the CPU utilization is but one type of resource utilization that may be measured in the accessing device for search result prioritization. Other resource utilization measures that may me measured for search result prioritization include memory utilization, bandwidth, etc. In an alternative embodiment, the search results may be automatically prioritized if the accessing device is of a type having limited resources, in lieu of measuring the resource utilization of the accessing device. For example, when the accessing device is a cellphone or mobile device, the resource utilization mechanism 156 may force a web page that requires high resource utilization to drop in the search results versus similar but less intensive web pages. In addition, the resource utilization mechanism 156 may prioritize the search results based on what applications are already running on the accessing device. For example, if an important application for a business need is utilizing processor resources, then it is more imperative to reduce processor utilization for web pages.

FIG. 6 is a flow diagram of example processing for link and/or content categorization and management using resource utilization measures, according to an embodiment of the present invention. In carrying out the processing for link and/or content categorization and management, the steps discussed below (blocks 600-630) are performed. These steps are set forth in their preferred order. It must be understood, however, that the various steps may occur at different times relative to one another than shown, or may occur simultaneously. Moreover, those skilled in the art will appreciate that one or more of the steps may be omitted. Control begins a block 600. Control then continues to block 605 where the user enters the search terms 215 in the entry field via user interface 200 and selects the “Search” button 217. Control then continues to block 610 where the script 154 sends the search terms 215 to the search engine 150. Control then continues to block 615 where the search engine 150 performs the search using the search terms 215.

Control then continues to block 620 where the search engine 150, along with the resource utilization mechanism 156, creates the search results and sends them to the browser 134, along with historical resource utilization measures associated with web pages, web sites, and/or domains within the search results. In this regard, a web page is created that when interpreted on the accessing device displays search results that include the indicia 220 indicative of the historical resource utilization measures. Control then continues to block 625 where the user is prompted if the user selects a link to a highly intensive web page (e.g., having a historical resource utilization measure greater than a threshold) from among the displayed search results. The prompt may, for example, inform the user that the highly intensive web page cannot be selected, or inform the user that the selected web page may adversely affect the performance of the accessing device and request the user to confirm selection of the highly intensive web page. Control then continues to block 630 where the logic of FIG. 6 returns.

The logic of FIG. 6 may be executed at any time to allow the user to add search terms, or to change the search terms currently being displayed on the user interface 200.

In the example shown in FIG. 6, search results are annotated with indicia indicative of the historical resource utilization measures. In general, links within web pages or in search results may indicate the required resource utilization, or an approximation thereof, to allow a user to choose which links to select based on the available resources of the accessing device. Preferably, the user sets rules to prevent highly intensive links from being followed when the available resources of the accessing device are not robust enough to handle those highly intensive links. For example, the system will prompt the user with a message such as, “This link may slow your device considerably. Do you really want to do this?”

FIG. 7 is a flow diagram of example processing for power conservation using resource utilization measures, according to an embodiment of the present invention. In carrying out the processing for power conservation, the steps discussed below (blocks 700-745) are performed. These steps are set forth in their preferred order. It must be understood, however, that the various steps may occur at different times relative to one another than shown, or may occur simultaneously. Moreover, those skilled in the art will appreciate that one or more of the steps may be omitted. Control begins a block 700. Control then continues to block 705 where the user enters the search terms 215 in the entry field via user interface 200 and selects the “Search” button 217. Control then continues to block 710 where the script 154 sends the search terms 215 to the search engine 150. Control then continues to block 715 where the search engine 150 performs the search using the search terms 215.

Control then continues to block 720 where the search engine 150, along with the resource utilization mechanism 156, creates the search results and sends them to the browser 134, along with historical resource utilization measures associated with web pages, web sites, and/or domains within the search results. In this regard, a web page is created that when interpreted on the accessing device displays either normal search results or prioritized search results having content based on the historical resource utilization measures. The normal search results are provided by the web site ranking algorithm of the search engine 150. The resource utilization mechanism 156 modifies the normal search results based on the historical resource utilization measures, which were previously calculated as discussed above with reference to FIG. 4, to provide the prioritized search results. Control then continues to block 725 where the remaining battery life of the accessing device is measured and compared to a threshold level. For example, a parameter associated with the remaining battery life, such as the battery's output voltage, may be measured and compared with a threshold value. If the measured remaining battery life is below the threshold level (block 725=Yes), control then continues to block 730 where prioritized search results are displayed in the results pane 210 by interpreting the downloaded page based on the historical resource utilization measures. Control then continues to block 732 where the user is prompted if the user selects a link to a highly intensive web page from among the prioritized search results. Control then continues to block 735 where the logic of FIG. 5 returns.

On the other hand, if the measured remaining battery life of the accessing device is not below the threshold level (block 725=No), control then continues to block 740 where the normal search results are displayed in the results pane 210 by interpreting the downloaded page. Control then continues to block 745 where the logic of FIG. 7 returns.

The logic of FIG. 7 may be executed at any time to allow the user to add search terms, or to change the search terms currently being displayed on the user interface 200.

Preferably, the logic of FIG. 7 would be used to conserve power in a mobile device. Based on the remaining battery life in a cellphone, for instance, a user may wish to access less CPU intensive content, since resource intensive web pages would sap the remaining battery power much faster than static text. The mobile device would automatically go into a power conservation mode when the battery life drops below a certain threshold (which is preferably a default value that is user alterable), and the mobile device would prompt the user when he/she selects a link to a CPU intensive web page. Additionally, search results and other links may be prioritized to take into account the remaining battery life, thereby dropping CPU intensive links in the search results, or even replacing the CPU intensive links with similar, albeit less CPU intensive alternative links.

One skilled in the art will appreciate that many variations are possible within the scope of the present invention. For example, one skilled in the art will appreciate that the calculation of historical resource utilization measures and the use of those measures for providing intelligent handling of web activity is not limited to implementation within the context of a search as shown in FIGS. 2-7, but rather implementation may occur within the context of any indexing service or local indexing application. Thus, while the present invention has been particularly shown and described with reference to preferred embodiments thereof, it will be understood by those skilled in the art that these and other changes in form and details may be made therein without departing from the spirit and scope of the present invention.

What is claimed is:

1. A computer-implemented method for providing intelligent handling of web activity, the computer-implemented method comprising the steps of:
measuring resource utilization on a client system in response to the client system at least one of loading and running a web page;
creating a web page that when interpreted on a client system displays content that is based on the resource utilization measured in the measuring step.

2. The computer-implemented method as recited in claim 1, wherein the measuring step includes the step of determining at least one of a change in processor utilization and a change in memory utilization in response to at least one of loading and running a web page.

3. The computer-implemented method as recited in claim 1, wherein the measuring step includes the step of aggregating the resource utilization measured on a plurality of client systems for each of a plurality of web pages so that each web page has associated therewith an aggregated measure of resource utilization, and wherein the creating step includes the step of providing a web page that when interpreted on a client system displays content that is based on one or more of the aggregated measures.

4. The computer-implemented method as recited in claim 3, wherein the measuring step includes the step of updating one or more of the aggregated measures.

5. The computer-implemented method as recited in claim 3, wherein the providing step includes the step of displaying search results that include a list of links to web pages listed in an order based at least partially on one or more of the aggregated measures.

6. The computer-implemented method as recited in claim 3, wherein the providing step includes the step of displaying search results that include a list of links to web pages one or more of which is/are listed with indicia based on the aggregated measure associated therewith.

7. The computer-implemented method as recited in claim 3, wherein the providing step includes the step of displaying search results that include a list of links to web pages, and the computer-implemented method further comprising the step of:
prompting the user to confirm selection of a selected link if the selected link is to a web page the aggregated measure of which is greater than a threshold.

8. The computer-implemented method as recited in claim 3, further comprising the step of:
measuring a parameter associated with the remaining battery life of a client system, and if the measured parameter indicates that the remaining battery life of the client system is less than a threshold value then the providing step includes the step of displaying search results that include links to web pages listed in an order based at least partially on one or more of the aggregated measures.

9. The computer-implemented method as recited in claim 3, further comprising the step of:
measuring a parameter associated with the remaining battery life of a client system, and if the measured parameter indicates that the remaining battery life of the client system is less than a threshold value then the providing step includes the step of displaying search results that include a list of links to web pages one or more of which is/are listed with indicia based on the aggregated measure associated therewith.

10. The computer-implemented method as recited in claim 3, wherein the providing step includes the step of displaying search results that include a list of links to web pages, and the computer-implemented method further comprising the steps of:
measuring a parameter associated with the remaining battery life of a client system;
and when the measured parameter indicates that the remaining battery life of the client system is less than a threshold value, prompting the user to confirm selection of a selected link if the selected link is to a web page the aggregated measure of which is greater than a threshold.

11. A computer program product for providing intelligent handling of web activity, comprising:
a plurality of instructions provided on a signal-bearing media, wherein the instructions when executed by at least one processor of a digital computing device, cause the digital computing device to perform the steps of:
measuring resource utilization on a client system in response to the client system at least one of loading and running a web page;
creating a web page that when interpreted on a client system displays content that is based on the resource utilization measured in the measuring step.

12. The computer program product as recited in claim 11, wherein the measuring step includes the step of determining at least one of a change in processor utilization and a change in memory utilization in response to at least one of loading and running a web page.

13. The computer program product as recited in claim 11, wherein the measuring step includes the step of aggregating the resource utilization measured on a plurality of client systems for each of a plurality of web pages so that each web page has associated therewith an aggregated measure of resource utilization, and wherein the creating step includes the step of providing a web page that when interpreted on a client system displays content that is based on one or more of the aggregated measures.

14. The computer program product as recited in claim 11, wherein the instructions when executed by at least one processor of a digital computing device, further cause the digital computing device to perform the step of:
prompting the user to confirm selection of a selected link if the selected link is to a web page the measured resource utilization of which is greater than a threshold.

15. The computer program product as recited in claim 11, wherein the signal-bearing media comprises recordable media.

16. The computer program product as recited in claim 11, wherein the signal-bearing media comprises communications media.

17. An apparatus comprising:
at least one processor;
a memory coupled to the at least one processor;
a web page resource utilization mechanism residing in the memory and executed by the at least one processor, the web page resource utilization mechanism measuring resource utilization on a client system in response to the client system at least one of loading and running a web page, and creating a web page that when interpreted on a client system displays content that is based on the measured resource utilization.

18. The apparatus as recited in claim 17, wherein the resource utilization measured by the web page resource utilization mechanism is at least one of a change in processor utilization and a change in memory utilization on the client system in response to the client system at least one of loading and running a web page.

19. The apparatus as recited in claim 17, wherein the web page resource utilization mechanism aggregates the resource utilization measured on a plurality of client systems for each of a plurality of web pages so that each web page has associated therewith an aggregated measure of resource utilization, and wherein the web page resource utilization mechanism provides a web page that when interpreted on a client system displays content that is based on one or more of the aggregated measures.

20. The apparatus as recited in claim 17, wherein the web page resource utilization mechanism prompts the user to confirm selection of a selected link if the selected link is to a web page the measured resource utilization of which is greater than a threshold.
